(19) United States
(12) Patent Application Publication
(10) Pub. No.: US 2024/0015423 A1
(43) Pub. Date: Jan. 11, 2024

(54) MIGRATION SUBSCRIBER LINE TERMINAL, TRANSFER METHOD AND OPTICAL ACCESS SYSTEM

(71) Applicant: NIPPON TELEGRAPH AND TELEPHONE CORPORATION, Tokyo (JP)

(72) Inventors: Satoshi SHIMAZU, Musashino-shi, Tokyo (JP); Tomoaki YOSHIDA, Musashino-shi, Tokyo (JP); Takayoshi TASHIRO, Musashino-shi, Tokyo (JP); Kenta ITO, Musashino-shi, Tokyo (JP)

(73) Assignee: NIPPON TELEGRAPH AND TELEPHONE CORPORATION, Tokyo (JP)

(21) Appl. No.: 18/035,212

(22) PCT Filed: Nov. 10, 2020
(86) PCT No.: PCT/JP2020/041916

§ 371 Date: May 3, 2023

(51) Int. Cl. H04Q 11/00

(52) U.S. Cl. CPC H04Q 11/0067; H04Q 2011/009

(57) ABSTRACT

A transition destination subscriber line terminal station device in an optical access system including: a transition source subscriber line terminal station device before device replacement; and the transition destination subscriber line terminal station device that is a device replacement destination, the transition destination subscriber line terminal station device including: a higher-level device side transition unit including a higher-level port for connecting to the higher-level device and a first transition port that transfers data transferred from the higher-level device to the transition source subscriber line terminal station device; a subscriber side transfer unit including subscriber side connection ports for connecting to one or more subscriber line terminal devices, and a second transition port that transfers data transmitted from the subscriber line terminal devices to the transition source subscriber line terminal station device; a transfer table setting unit that changes a setting of a transfer table in which a port at which data is received, a destination of the data, and a port of a transfer destination of the data are associated with each other; and a transfer control unit that performs data transfer to the transition source subscriber line terminal station device via at least the first transition port in accordance with the transfer table.

### TECHNICAL FIELD

The present invention relates to a transition destination subscriber line terminal station device, a transfer method, and an optical access system.

### BACKGROUND ART

FIG. 10 is a diagram illustrating a configuration of an optical access system 1000 in a conventional technology. The optical access system 1000 illustrated in FIG. 10 includes three optical network units (ONUs) 100-1 to 100-3, three optical line terminals (OLTs) 200-1 to 200-3, and two relay devices 300-1 to 300-2. User terminals 400-1 to 400-3 are connected to the ONUs 100-1 to 100-3, respectively. Note that the numbers of the ONUs 100, the OLTs 200, the relay devices 300, and the user terminals 400 are examples.

An OLT 200 is connected to an ONU 100 via an optical fiber, aggregates user data transmitted from respective user terminals 400, and transfers the user data to a relay device 300 belonging to a network to which the user terminals 400 belong. The OLT 200 distributes the data transmitted from the relay device 300 belonging to the network to which the user terminals 400 belong to the ONUs 100 to which the user terminals 400 as destinations are connected. In a case where the OLT 200 is physically connected to the ONUs 100 by a single star (SS) method, the OLT 200 is connected on a one-to-one basis. The OLT 200 includes a plurality of ports connected on a one-to-N basis (N is an integer greater than or equal to 1) in the case of a passive optical network (PON), and includes a plurality of ports connected to a plurality of the relay devices 300. For example, as illustrated in FIG. 10, the OLT 200 includes a plurality of ports 202-1 to 202-3 for connecting to the plurality of ONUs 100, and a plurality of ports 203-1 to 203-2 for connecting to the plurality of relay devices 300.

The OLT 200 includes a transfer table in which transfer destinations of the user data transmitted from the user terminals 400 are registered, and transfers the user data transmitted from the user terminals 400 from the ports to ports of the transfer destinations in accordance with the transfer table.

Even if a failure does not occur, the OLT 200 needs to be replaced in a planned manner for aged deterioration or provision of a new function. Hereinafter, replacement of an OLT 20 with a new OLT 200 for aged deterioration or provision of a new function will be described as transition. In the transition of the OLT 200, a setting inside the OLT 200 including a setting of the transfer table can be changed by command input or the like. On the other hand, in connection switching of the optical fiber from the OLT 200 as a transition source to the OLT 200 as a transition destination, it takes time to change a physical port to which a cable is connected.

It is desirable that communication interruption of the user terminals 400 caused by cable connection change work is as short as possible. If the entire work is prolonged, it is difficult to secure work operation. The transition is completed only after all steps are ended. If connection work, setting change work, and the like occur many times during that time, an entire work period increases, and operation of controlling the entire work is also required while securing the work operation during that time.

A conventional transition procedure will be described with reference to FIGS. 11 to 13. As illustrated in FIG. 11, a description will be given with the OLT 200-2 as a transition source OLT, and the OLT 200-3 as a transition destination OLT. As illustrated in FIG. 11, the transition source OLT 200-2 includes the plurality of ports 202-1 to 202-3 for connecting to the ONUs 100 and a port 203 for connecting to the relay device 300. Similarly, the transition destination OLT 200-3 includes a plurality of ports 205-1 to 205-3 for connecting to the ONUs 100 and a port 204 for connecting to the relay device 300. A description will be given assuming that connection relationship is switched from the transition source OLT 200-2 to the transition destination OLT 200-3, as indicated by dotted lines in FIG. 11, in the transition of the OLT 200.

(Step 1)

First, an operator newly installs the transition destination OLT 200-3 (FIG. 12(A)).

(Step 2)

Next, the operator performs setting of the transfer table by copying or converting the transfer table to be used in the transition destination OLT 200-3 from the transition source OLT 200-2. As a result, the connection relationship between the ports of the transition destination OLT 200-3 is set similarly to that of the transition source OLT 200-2 (FIG. 12(B)). During a period from step 1 to step 2, the transition source OLT 200-2 can communicate with both the ONUs 100 and the relay device 300.

(Step 3)

Next, the operator removes a connection line 450 (optical fiber) connecting the relay device 300 and the transition source OLT 200-2 together from the transition source OLT 200-2, and reattaches the removed connection line 450 to the port 204 of the transition destination OLT 200-3 (FIG. 12(C)). As a result, communication interruption occurs in each of the user terminals 400-1 to 400-3.

(Step 4)

Next, the operator removes a connection line 460 (optical fiber) connecting the transition source OLT 200-2 and the ONU 100-1 together from the transition source OLT 200-2, and reattaches the removed connection line 460 to the port 205-1 of the transition destination OLT 200-3. Communication restoration of the ONU 100-1 is confirmed in the transition destination OLT 200-3. The communication restoration of the ONU 100-1 is confirmed, whereby communication between the user terminal 400-1 and the relay device 300 becomes possible (FIG. 12(D)).

(Step 5)

Next, the operator removes a connection line 470 (optical fiber) connecting the transition source OLT 200-2 and the ONU 100-2 together from the transition source OLT 200-2, and reattaches the removed connection line 470 to the port 205-2 of the transition destination OLT 200-3. Communication restoration of the ONU 100-2 is confirmed in the transition destination OLT 200-3. The communication restoration of the ONU 100-2 is confirmed, whereby communication between the user terminal 400-2 and the relay device 300 becomes possible (FIG. 13(A)).

(Step 6)

Next, the operator removes a connection line 480 (optical fiber) connecting the transition source OLT 200-2 and the ONU 100-3 together from the transition source OLT 200-2, and reattaches the removed connection line 480 to the port 205-3 of the transition destination OLT 200-3. Communication restoration of the ONU 100-3 is confirmed in the transition destination OLT 200-3. The communication restoration of the ONU 100-3 is confirmed, whereby communication between the user terminal 400-3 and the relay device 300 becomes possible (FIG. 13(B)).

In the above example, three ONUS 100 have been described as an example; however, in a case where four or more ONUs 100 are connected to the transition source OLT 200-2, processing similar to that in step 4 is executed as many as the number of ONUs 100.

(Step 7)

After the connection switching of all the ONUs 100 connected to the transition source OLT 200-2 is completed, the operator removes the transition source OLT 200-2 (FIG. 13(C)). As a result, transition processing is completed.

### CITATION LIST

### Patent Literature

Patent Literature 1: JP 2011-71951 A

### Non Patent Literature

Non Patent Literature 1: Mitsui et al., “N:M PON Protection Architecture for 10 Gbit/s Class PON Systems, The IEICE Transactions B, Vol. J96-B, No. 3, pp. 283-291

### SUMMARY OF INVENTION

### Technical Problem

As described above, in a case where the connection line to the relay device 300 is switched to the transition destination OLT 200-3 first, the user terminal 400 connected to the ONU 100 for which the connection line has been switched first can recover early. On the other hand, the user terminal 400 connected to the ONU 100 whose switching order is late continues to be disconnected until the switching is completed, so that communication interruption time increases.

In a case where the connection line to the ONU 100 is switched to the transition destination OLT 200-3 first (step 3 and steps 4 to 6 are replaced with each other), the connection line connected to each ONU 100 is first switched from the transition source OLT 200-2 to the transition destination OLT 200-3. In a state where only the connection line is switched, it is a state where the communication is disconnected, and the communication cannot be resumed unless the switching of the connection line to the relay device 300 is also completed, and it takes time for the communication restoration.

As described above, in the conventional transition method, the switching of a connection between a higher-level device (for example, the relay device 300) and a lower-level device (for example, the ONU 100) and setting change of the OLT 200 are completed, and the transition is completed. Thus, in the transition of the OLT 200, it takes time to complete not only switching work but also entire work. For that reason, there has been a problem that an influence of user's communication interruption is large.

In view of the above circumstances, an object of the present invention is to provide a technology capable of suppressing the influence of communication interruption in transition of a device.

### Solution to Problem

An aspect of the present invention is a transition destination subscriber line terminal station device in an optical access system including: a transition source subscriber line terminal station device before device replacement, the transition source subscriber line terminal station device communicating with a higher-level device and one or more subscriber line terminal devices; and the transition destination subscriber line terminal station device that is a device replacement destination, the transition destination subscriber line terminal station device including: a higher-level device side transition unit including a higher-level port for connecting to the higher-level device and a first transition port that transfers data transferred from the higher-level device to the transition source subscriber line terminal station device; a subscriber side transfer unit including subscriber side connection ports for connecting to one or more subscriber line terminal devices, and a second transition port that transfers data transmitted from the subscriber line terminal devices to the transition source subscriber line terminal station device; a transfer table setting unit that changes a setting of a transfer table in which a port at which data is received, a destination of the data, and a port of a transfer destination of the data are associated with each other; and a transfer control unit that performs data transfer to the transition source subscriber line terminal station device via at least the first transition port in accordance with the transfer table.

An aspect of the present invention is a transfer method performed by a transition destination subscriber line terminal station device in an optical access system including: a transition source subscriber line terminal station device before device replacement, the transition source subscriber line terminal station device communicating with a higher-level device and one or more subscriber line terminal devices; and the transition destination subscriber line terminal station device that is a device replacement destination, the transfer method including: transferring, to the transition source subscriber line terminal station device, data transmitted from the higher-level device, via a first transition port connected to the transition source subscriber line terminal station device after a connection with the higher-level device is switched from the transition source subscriber line terminal station device to the transition destination subscriber line terminal station device; and transferring, to the transition source subscriber line terminal station device, data transmitted from the one or more subscriber line terminal devices, via a second transition port connected to the transition source subscriber line terminal station device after connections with the one or more subscriber line terminal devices are switched from the transition source subscriber line terminal station device to the transition destination subscriber line terminal station device.

An aspect of the present invention is an optical access system including: a transition source subscriber line terminal station device before device replacement, the transition source subscriber line terminal station device communicating with a higher-level device and one or more subscriber line terminal devices; and a transition destination subscriber line terminal station device that is a device replacement destination, in which the transition destination subscriber line terminal station device includes: a higher-level device side transition unit including a higher-level port for connecting to the higher-level device and a first transition port that transfers data transferred from the higher-level device to the transition source subscriber line terminal station device; a subscriber side transfer unit including subscriber side connection ports for connecting to one or more subscriber line terminal devices, and a second transition port that transfers data transmitted from the subscriber line terminal devices to the transition source subscriber line terminal station device; and a transfer control unit that performs data transfer to the transition source subscriber line terminal station device via at least the first transition port at a time of device replacement, and in the transition source subscriber line terminal station device, with a start of device replacement, a port that has been connected to the higher-level device is connected to the first transition port, and ports that have been connected to the one or more subscriber line terminal devices are connected to the second transition port, and data transferred from the first transition port is transferred to a destination via the second transition port, and data transferred from the first transition port is transferred to a destination via the second transition port.

### Advantageous Effects of Invention

According to the present invention, it is possible to suppress the influence of communication interruption in transition of a device.

### BRIEF DESCRIPTION OF DRAWINGS

FIG. 1 is a diagram illustrating a configuration example of an optical access system 1 in the present invention.

FIG. 2 is a schematic diagram illustrating a specific configuration of a transition destination OLT 20.

FIG. 3 is a diagram for explaining an outline of processing at the time of OLT transition in an optical access system.

FIG. 4 is a diagram for explaining the outline of the processing at the time of OLT transition in the optical access system.

FIG. 5 is a diagram for explaining the outline of the processing at the time of OLT transition in the optical access system.

FIG. 6 is a sequence diagram for explaining a flow of processing at the time of transition in the optical access system.

FIG. 7 is a diagram for explaining a setting change of a transfer table at the time of transition in the optical access system.

FIG. 8 is a diagram for explaining a setting change of the transfer table at the time of transition in the optical access system.

FIG. 9 is a diagram for explaining a setting change of the transfer table at the time of transition in the optical access system.

FIG. 10 is a diagram illustrating a configuration of an optical access system in a conventional technology.

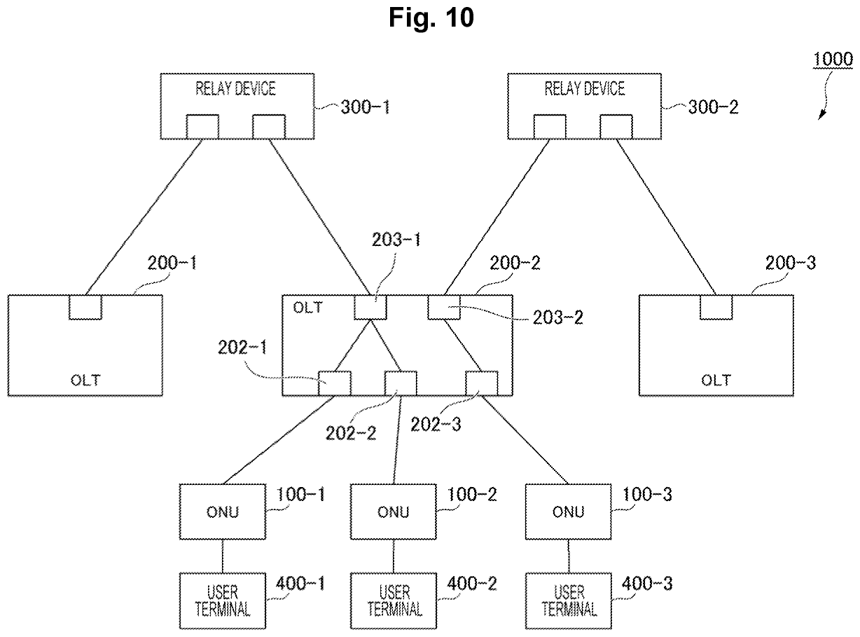

FIG. 11 is a schematic diagram for explaining a conventional transition procedure.

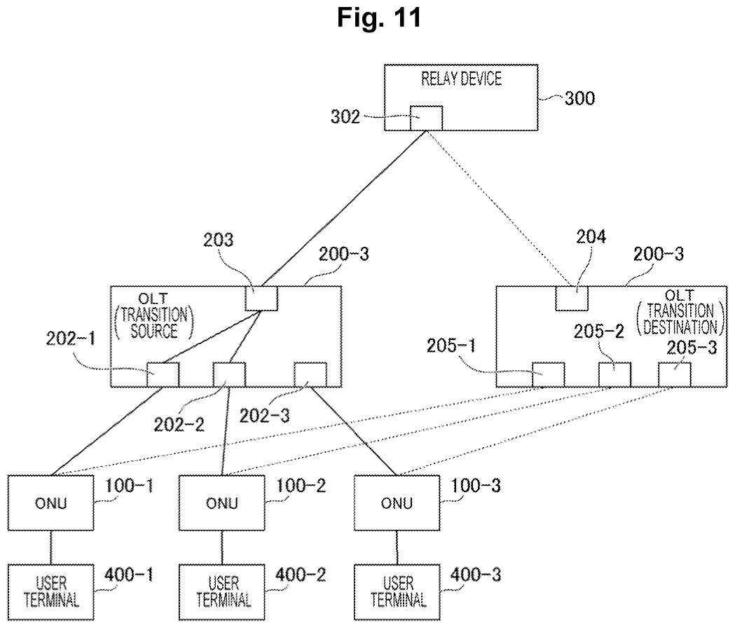

FIG. 12 is a schematic diagram for explaining the conventional transition procedure.

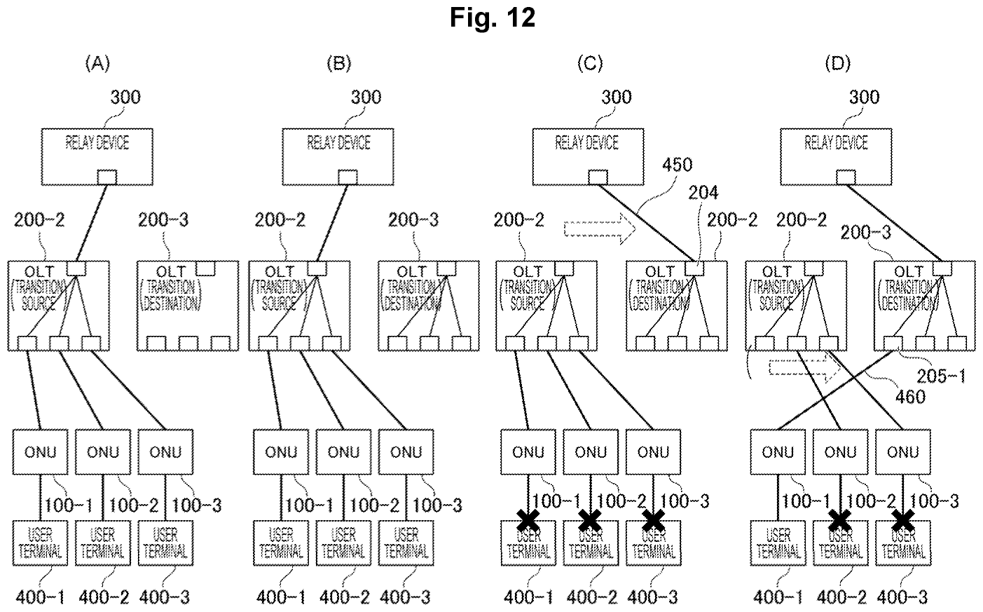

FIG. 13 is a schematic diagram for explaining the conventional transition procedure.

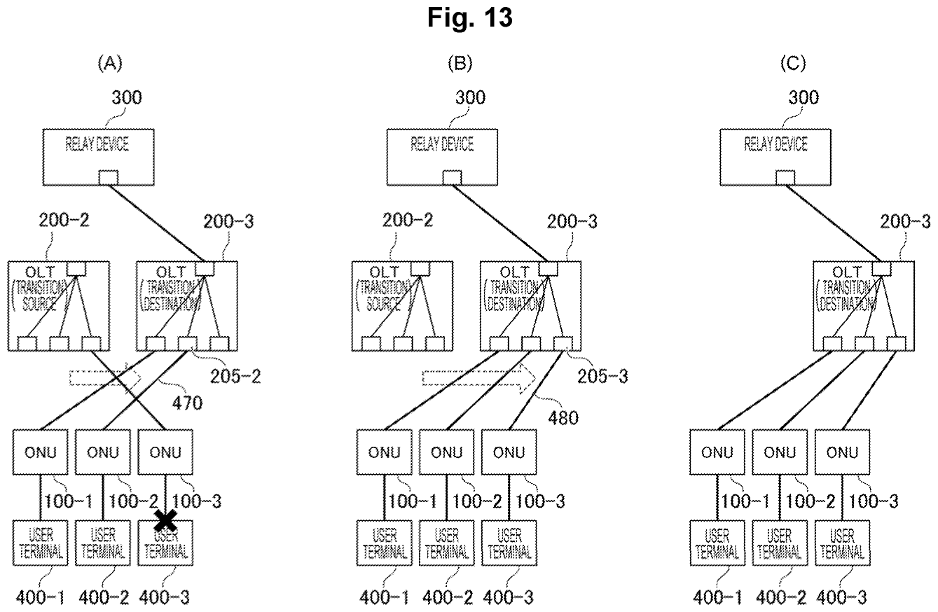

### DESCRIPTION OF EMBODIMENTS

Hereinafter, an embodiment of the present invention will be described with reference to the drawings.

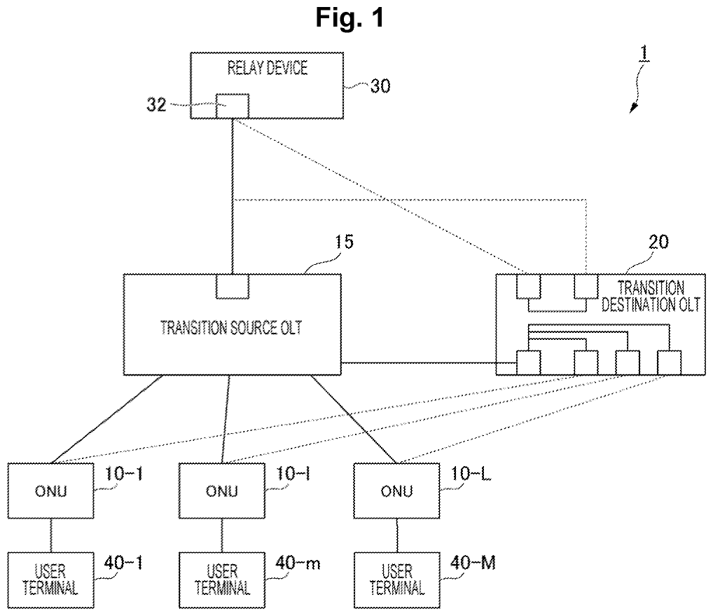

FIG. 1 is a diagram illustrating a configuration example of an optical access system 1 in the present invention.

The optical access system 1 includes one or more ONUS 10-1 to 10-L (L is an integer greater than or equal to 1), a transition source OLT 15 (transition source subscriber line terminal station device), a transition destination OLT 20 (transition destination subscriber line terminal station device), and a relay device 30. The transition source OLT 15 and the ONUS 10-1 to 10-L are connected to each other via optical fibers. The transition source OLT 15 and the relay device 30 are connected to each other via an optical fiber. The numbers of the ONUS 10, the transition source OLTs 15, the transition destination OLTs 20, and the relay devices 30 included in the optical access system 1 are not particularly limited.

User terminals 40-1 to 400-M (M is an integer greater than or equal to 1) are connected to the ONUS 10-1 to 10-L, respectively. In FIG. 1, the user terminal 40-1 is connected to the ONU 10-1, the user terminal 40-m (m≤M) is connected to the ONU 10-1 (1≤L), and the user terminal 40-M is connected to the ONU 10-L. Further, the relay device 30 is connected to a higher level of the transition source OLT 15, and the ONUS 10-1 to 10-L are connected to a lower level of the transition source OLT 15. In the following description, the ONUS 10-1 to 10-L will be simply referred to as ONUS 10 unless otherwise distinguished.

An ONU 10 is installed, for example, in the home of a subscriber who receives provision of a communication service. The ONU 10 transmits user data transmitted from a user terminal 40 to a destination communication device via the transition source OLT 15 and the relay device 30. In a case where a connection destination is changed from the transition source OLT 15 to the transition destination OLT 20 due to transition, the ONU 10 transmits the user data transmitted from the user terminal 40 to the destination communication device via the transition destination OLT 20 and the relay device 30.

The transition source OLT 15 is an OLT that is replaced for aged deterioration or provision of a new function. The transition source OLT 15 includes a transfer table in which a destination, a reception port, and a transfer destination port are associated with each other, and transfers data in accordance with the transfer table. For example, before the transition, the transition source OLT 15 transfers data transmitted from the ONU 10, to other ONUs 10 or the relay device 30 in accordance with the transfer table, and transfers data transmitted from the relay device 30, to the ONU 10 in accordance with the transfer table. The transition source OLT 15 transmits and receives data via the transition destination OLT 20 during the transition. As a result, occurrence of communication interruption can be suppressed, and duration of communication can be lengthened.

The transition destination OLT 20 is an OLT to be a transition destination from the transition source OLT 15. The transition destination OLT 20 includes a relay device transfer port (first transfer port) for transferring the data transmitted from the relay device 30 (higher-level device) to return the data to the transition source OLT 15, and a transition source transfer port (second transfer port) for transferring the data transmitted from the ONU 10 to return the data to the transition source OLT 15. As a result, the transition destination OLT 20 can continue communication of the user terminal 40 even during switching of other ONUs 10.

The relay device 30 is a device located at the higher level of the transition source OLT 15 and the transition destination OLT 20. The relay device 30 relays data transferred from the transition source OLT 15 and the transition destination OLT 20 to a relay device belonging to a destination network. The relay device 30 relays data relayed from another relay device to the transition source OLT 15 or the transition destination OLT 20.

The user terminal 40 is a communication terminal possessed by the subscriber. The user terminal 40 transmits data to the ONU 10 depending on operation. The user terminal 40 receives the data transmitted from the ONU 10. The user terminal 40 is configured using an information processing device.

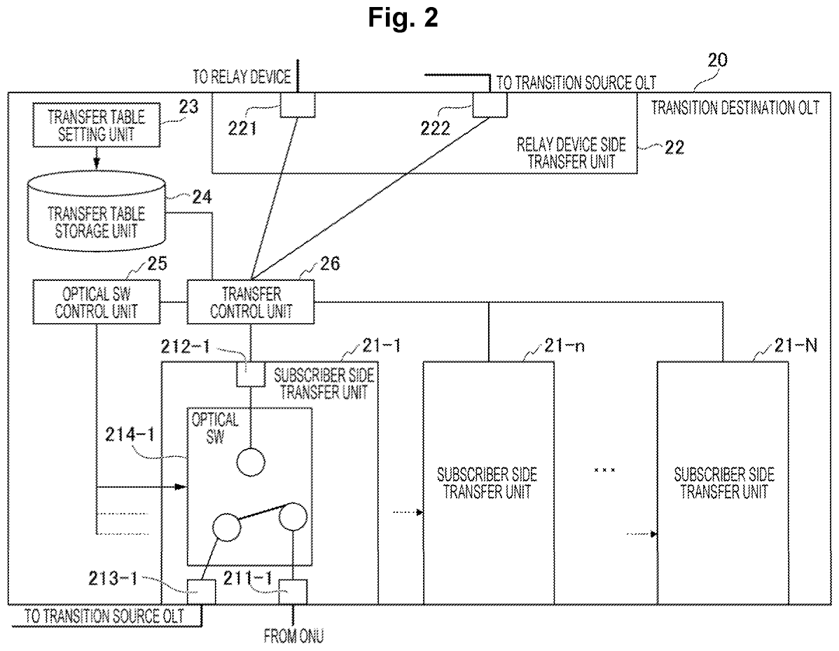

FIG. 2 is a schematic diagram illustrating a specific configuration of the transition destination OLT 20.

The transition destination OLT 20 includes one or more subscriber side transfer units 21-1 to 21-N, a relay device side transfer unit 22, a transfer table setting unit 23, a transfer table storage unit 24, an optical SW control unit 25, and a transfer control unit 26.

The subscriber side transfer units 21-1 to 21-N transmit and receive data to and from the ONUS 10. For example, one subscriber side transfer unit 21 transmits and receives data to and from one ONU 10. Note that, in a case where one subscriber side transfer unit 21 transmits and receives data to and from a plurality of ONUs 10, it is sufficient that a power splitter is provided between the subscriber side transfer unit 21 and the plurality of ONUs 10. The subscriber side transfer unit 21 includes a port 211, a port 212, a port 213, and an optical SW 214. In the following description, in a case where the port 211, the port 212, the port 213, and the optical SW 214 included in the subscriber side transfer unit 21 are distinguished for each subscriber side transfer unit 21, they are distinguished by attaching branch numbers.

One of the ports included in the subscriber side transfer unit 21 is set as the transition source transfer port. Note that, which one of the ports 211 to 213 is set as the transition source transfer port is set by input from an external device. The external device is, for example, a communication device operated by an operator, and performs setting of the transfer table of the transition source OLT 15 and the transition destination OLT 20, setting of the ports, and the like. In the following, a description will be given with the port 211 as the ONU connection port 211 (subscriber side connection port), and the port 213 as the transition source transfer port 213.

The ONU connection port 211 is a port to which the ONU 10 is connected. For example, an optical fiber connected to the ONU 10 is attached to the ONU connection port 211 during and after the transition.

The port 212 is a port connected to the relay device side transfer unit 22.

The transition source transfer port 213 is a port connected to the transition source OLT 15. For example, an optical fiber for connecting to the transition source OLT 15 is attached to the transition source transfer port 213 during and after the transition.

The optical SW 214 performs switching of a path under control of the optical SW control unit 25. For example, the optical SW 214 performs switching of the path to make conduction between the ONU connection port 211 and the port 212 under the control of the optical SW control unit 25. For example, the optical SW 214 performs switching of the path to make conduction between the ONU connection port 211 and the transition source transfer port 213 under the control of the optical SW control unit 25. When the path of the optical SW 214 is switched to make conduction between the ONU connection port 211 and the transition source transfer port 213, the data transmitted from the ONU 10 is output to the transition source transfer port 213 by the optical SW 214. As a result, the transition destination OLT 20 can transfer the data transmitted from the ONU 10 to the transition source OLT 15 during the transition.

The relay device side transfer unit 22 includes a plurality of ports 221 and 222. Although FIG. 2 illustrates a configuration in which the relay device side transfer unit 22 includes two ports, the relay device side transfer unit 22 may include three or more ports. One of the ports included in the relay device side transfer unit 22 is set as the relay device transfer port. Note that, which one of the ports 221 and 222 is set as the relay device transfer port is set by an input from the external device. In the following, a description will be given with the port 221 as the relay port 221 (higher-level port), and the port 222 as the relay device transfer port 222 (first transition port).

The relay port 221 is a port connected to the relay device 30. For example, an optical fiber connected to the relay device 30 is attached to the port 221 during and after the transition.

The relay device transfer port 222 is a port connected to the transition source OLT 15. For example, an optical fiber for connecting to the transition source OLT 15 is attached to the relay device transfer port 222 during and after the transition. The relay device transfer port 222 can transfer data at a transfer rate greater than or equal to a transfer rate of the relay port 221.

The transfer table setting unit 23 performs setting of the transfer table to be used in the transition destination OLT 20. For example, at the start of transition, the transfer table setting unit 23 copies the transfer table held by the transition source OLT 15 to generate the transfer table depending on an instruction from the external device. Further, the transfer table setting unit 23 updates the transfer table depending on an instruction from the external device.

The transfer table is stored in the transfer table storage unit 24. The transfer table storage unit 24 is configured using a storage device such as a magnetic storage device or a semiconductor storage device.

The optical SW control unit 25 controls switching of the path of the optical SW 214. For example, during the transition, the optical SW control unit 25 performs switching of the path to make conduction between the ONU connection port 211 and the transition source transfer port 213. For example, after completion of the transition, the optical SW control unit 25 performs switching of the path to make conduction between the ONU connection port 211 and the port 212.

The transfer control unit 26 transfers data between the subscriber side transfer unit 21 and the relay device side transfer unit 22 in accordance with the transfer table stored in the transfer table storage unit 24. For example, the transfer control unit 26 transfers data output from the port 212 to the relay port 221 or the relay device transfer port 222. For example, the transfer control unit 26 transfers data output from the relay device transfer port 222 to the relay port 221. Note that a transfer rule indicated in the transfer table is a transfer rule in a path between the port 212, the relay port 221, and the relay device transfer port 222. For that reason, a transfer rule in the optical SW 214 is different from the transfer rule indicated in the transfer table.

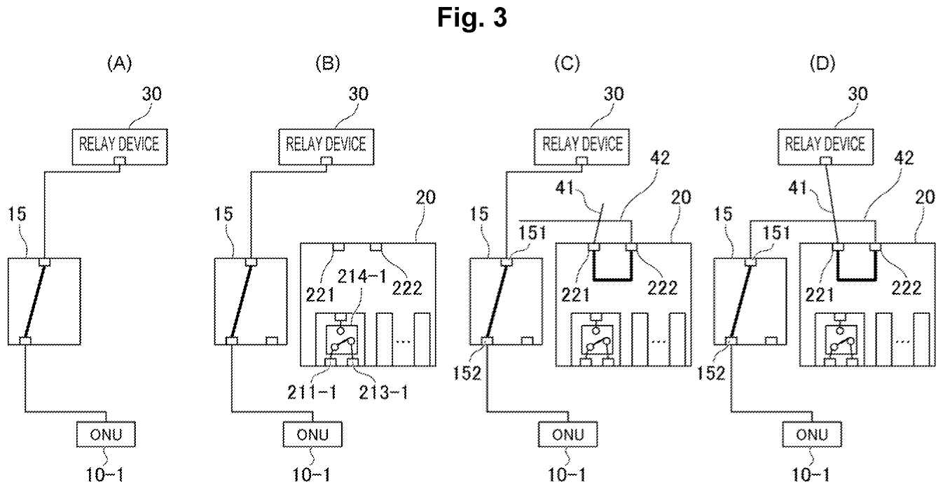

Next, with reference to FIGS. 3 to 5, a description will be given of an outline of processing at the time of OLT transition in the optical access system 1 of the present invention. FIGS. 3 to 5 are diagrams for explaining the outline of the processing at the time of OLT transition in the optical access system 1.

In a state before the start of transition, one or more ONUs 10 and the relay device 30 are in communication with each other via the transition source OLT 15 (FIG. 3(A)). Note that, in a case where description is not particularly necessary, description of other ONUs 10 is omitted in FIGS. 3 to 5. In FIG. 3(A), the ONU 10-1 is focused.

When starting the transition of the OLT, the operator installs the transition destination OLT 20 (FIG. 3(B)). At a time point when the transition destination OLT 20 is installed, the path of the optical SW 214 of transition destination OLT 20 is set so that conduction is made between the ONU connection port 211 and the transition source transfer port 213. FIG. 3(B) illustrates an example in which the path is set so that conduction is made between an ONU connection port 211-1 and a transition source transfer port 213-1 in the optical SW 214-1 of the transition destination OLT 20.

Next, the operator performs setting of the transfer table of the transition destination OLT 20 and wiring on the relay device 30 side of the transition destination OLT 20 (FIG. 3(C)). At this time point, as the setting of the transfer table, the operator performs setting so that data output from the relay port 221 is transferred to the relay device transfer port 222, and the data output from the relay device transfer port 222 is transferred to the relay port 221. Further, as the setting of the transfer table, the operator performs setting so that data received by the ONU connection port 211, more specifically, data received by the ONU connection port 211 and output from the port 212 is not transferred to the relay device 30. Thereafter, as illustrated in FIG. 3(C), the operator attaches an optical fiber 41 to the relay port 221 of the transition destination OLT 20 and attaches an optical fiber 42 to the relay device transfer port 222.

Next, the operator performs connection of the wiring on the relay device 30 side of the transition destination OLT 20 (FIG. 3(D)). Specifically, first, the operator removes the optical fiber connecting the relay device 30 and the transition source OLT 15 to each other. With this work, connection between the ONU 10-1 and the relay device 30 is disconnected, whereby communication interruption occurs in the ONU 10-1. The operator attaches the optical fiber 41 connected to the relay port 221 of the transition destination OLT 20 to a port of the relay device 30, and attaches the optical fiber 42 connected to the relay device transfer port 222 of the transition destination OLT 20 to a port 151 of the transition source OLT 15.

As a result, as illustrated in FIG. 3(D), data transfer can be performed in the order of the relay device 30⇒the relay port 221 of the transition destination OLT 20⇒the relay device transfer port 222⇒the port 151 of transition source OLT 15⇒a port 152 of the transition source OLT 15⇒the ONU 10-1. For data from the ONU 10-1, data transfer can be performed in a reverse order of the above. Communication restoration of the ONU 10-1 is confirmed in the transition destination OLT 20. The communication restoration of the ONU 10-1 is confirmed, whereby communication between the ONU 10-1 and the relay device 30 becomes possible.

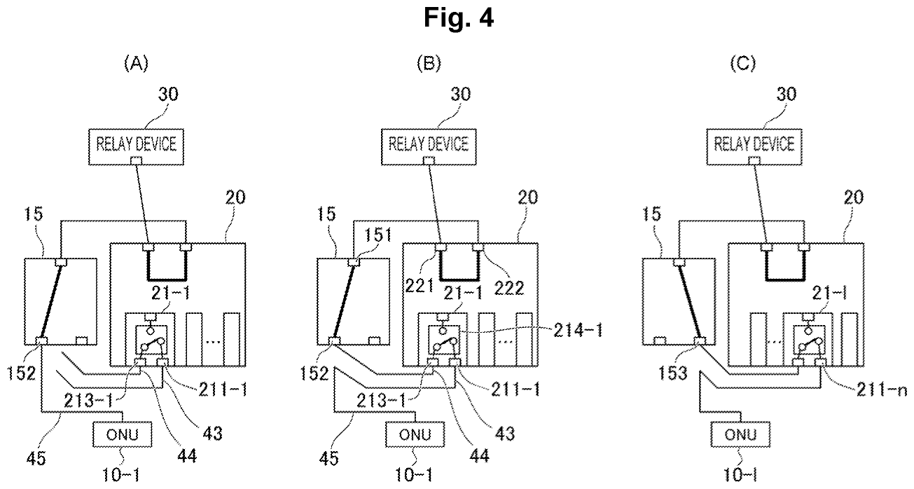

Next, the operator performs wiring on the ONU 10-1 side of the transition destination OLT 20 (FIG. 4(A)). Specifically, as illustrated in FIG. 4(A), the operator attaches an optical fiber 43 to the ONU connection port 211-1 and attaches an optical fiber 44 to the transition source transfer port 213-1.

Next, the operator performs connection of the wiring on the ONU 10-1 side of the transition destination OLT 20 (FIG. 4(B)). Specifically, first, the operator removes the optical fiber connecting the ONU 10-1 and the transition source OLT 15 to each other. With this work, connection between the ONU 10-1 and the relay device 30 is disconnected, whereby communication interruption occurs in the ONU 10-1.

The operator connects the optical fiber 43 connected to the ONU connection port 211-1 of the transition destination OLT 20 and the optical fiber 45 connected to the ONU 10-1 together. For example, the operator connects the optical fiber 43 and the optical fiber 45 together by fusion. Next, the operator attaches the optical fiber 44 connected to the transition source transfer port 213-1 of the transition destination OLT 20 to the port 152 of the transition source OLT 15.

As a result, as illustrated in FIG. 4(B), data transfer can be performed in the order of the ONU 10-1⇒the ONU connection port 211-1 of the transition destination OLT 20⇒the optical SW 214-1⇒the transition source transfer port 213-1⇒the port 152 of the transition source OLT 15⇒the port 151 of the transition source OLT 15⇒the relay device transfer port 222 of the transition destination OLT 20⇒the relay port 221 of the transition destination OLT 20⇒the relay device 30. In data transfer from the relay device 30, the data transfer can be performed in a reverse order of the above. Communication restoration of the ONU 10-1 is confirmed in the transition destination OLT 20. The communication restoration of the ONU 10-1 is confirmed, whereby communication between the ONU 10-1 and the relay device 30 becomes possible.

The operator performs the work illustrated in FIGS. 4(A) and 4(B) for the ONUS 10 connected to the transition source OLT 15 (FIG. 4(C)). FIG. 4(C) illustrates an example in which the work illustrated in FIGS. 4(A) and 4(B) is executed for the ONU 10-1 connected to the transition source OLT 15.

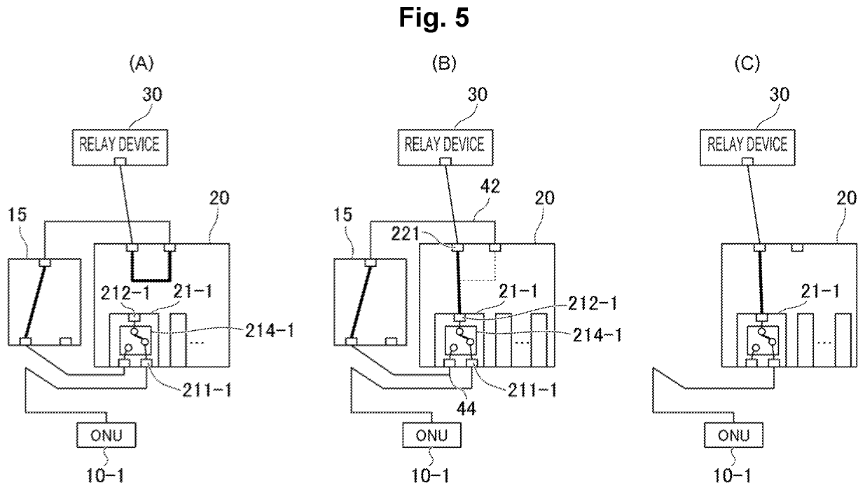

The transition destination OLT 20 performs switching of the path of the optical SW 214-1 in accordance with an instruction from the outside (FIG. 5(A)). Specifically, the optical SW control unit 25 performs switching of the path of the optical SW 214-1 so that conduction between the ONU connection port 211-1 and the port 212-1 is made. As a result, connection between the ONU 10-1 and the relay device 30 is disconnected, whereby communication interruption occurs in the ONU 10-1.

The operator performs setting of the transfer table of the transition destination OLT 20 (FIG. 5(B)). Specifically, as the setting of the transfer table, the operator performs setting so that data output from the port 212-1 of the subscriber side transfer unit 21-1 is transferred to the relay port 221 and data output from the relay port 221 is transferred to the port 212-1. Note that, since the setting for the ONU 10-1 is performed at the present time, the operator does not change the setting of the transfer table corresponding to the ONU 10 other than the ONU 10-1.

As a result, as illustrated in FIG. 5(B), transfer can be performed to the relay device 30⇒the relay port 221 of the transition destination OLT 20⇒the port 212-1⇒of the transition destination OLT 20⇒the optical SW 214-1 the ONU connection port 211-1 of the transition destination OLT 20⇒the ONU 10-1. Communication restoration of the ONU 10-1 is confirmed in the transition destination OLT 20. The communication restoration of the ONU 10-1 is confirmed, whereby communication between the ONU 10-1 and the relay device 30 becomes possible.

The operator performs the work illustrated in FIGS. 5(A) and 5(B) for the ONUS 10 connected to the transition destination OLT 20.

Thereafter, the operator removes the transition source OLT 15 and extra wiring (for example, the optical fibers 42 and 44).

As a result, the transition of the OLT is completed.

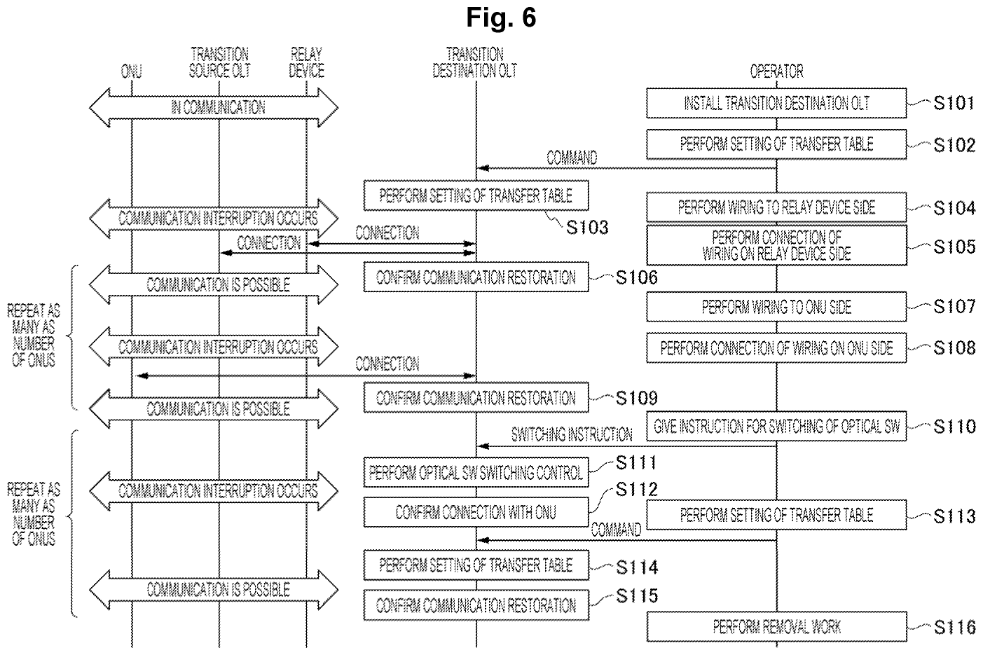

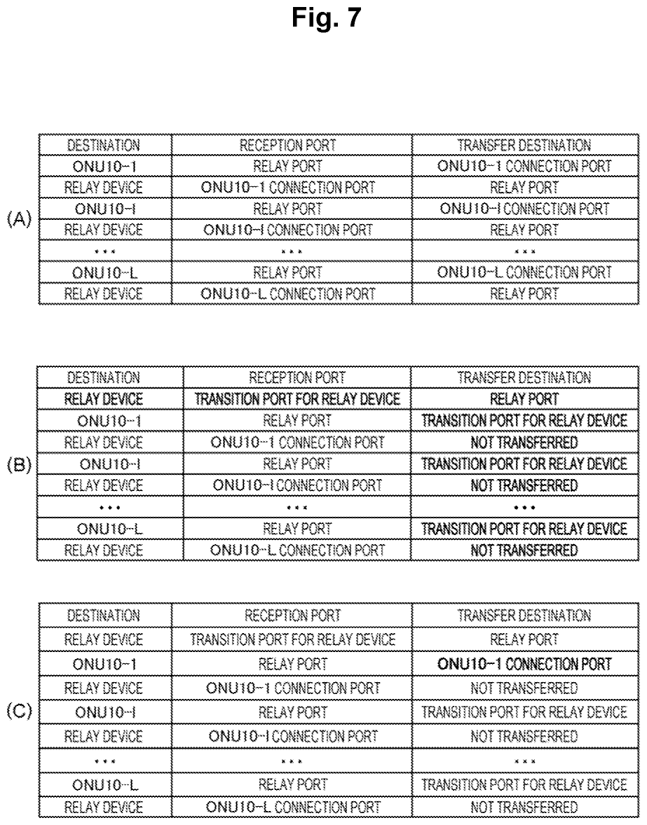

In FIGS. 3 to 5, the outline of the processing at the time of OLT transition has been described. Thus, next, with reference to FIGS. 6 to 9, a specific description will be given of an example of setting change of the transfer table and processing of each of functional units of the transition destination OLT 20. FIG. 6 is a sequence diagram illustrating a flow of the processing at the time of OLT transition in the optical access system 1. It is a diagram for explaining setting changes of the transfer tables illustrated in FIGS. 7 to 9.

At the start of the processing of FIG. 6, it is assumed that the ONU 10 and the relay device 30 are in communication with each other via the transition source OLT 15. It is assumed that the setting of the transfer table included in the transition source OLT 15 is as in FIG. 7(A). In the transfer table illustrated in FIG. 7(A), the setting is made so that in a case where data whose destination is the ONU 10-1 is received at a port (relay port) connected to the relay device 30, the received data is transferred to a port (ONU 10-1 connection port) to which the ONU 10-1 is connected. In the transfer table illustrated in FIG. 7(A), the setting is made so that in a case where data whose destination is the relay device 30 is received at the ONU 10-1 connection port, the received data is transferred to the relay port.

It is assumed that the transition of the OLT is started in such a state. First, the operator installs the transition destination OLT 20 (step S101). As a result, the transition destination OLT 20 is installed near the transition source OLT 15. Next, the operator operates the external device to perform setting of the transfer table of the transition destination OLT 20 (step S102). For example, the operator performs setting of the transfer table of the transition destination OLT 20 on the basis of the transfer table illustrated in FIG. 7(A). The external device transmits a setting change command to the transition destination OLT 20.

For example, the operator operates the external device to transmit, to the transition destination OLT 20, a command for causing contents 1 to 3 described below to be set in the transfer table.

(Content 1) A content for causing a destination “relay device 30”, a reception port “relay device transfer port 222”, and a transfer destination “relay port 221” to be set.

Content 1 is a content for causing settings to be set so that in a case where the data whose destination is the relay device 30 is received at the relay device transfer port 222 of the transition destination OLT 20, the received data is transferred to the relay port 221.

(Content 2) A content for causing a destination “ONU 10”, a reception port “relay port 221”, and a transfer destination “relay device transfer port 222” to be set.

Content 2 is a content for causing settings to be set so that in a case where the data whose destination is ONU 10 is received at the relay port 221, the received data is transferred to the relay device transfer port 222.

(Content 3) A content for causing a destination “relay device 30”, a reception port “ONU connection port 211”, and a transfer destination “not transferred” to be set.

Content 3 is a content for causing settings to be set so that in a case where the data whose destination is the relay device 30 is received at the ONU connection port 211, the received data is not transferred.

The transfer table setting unit 23 performs setting of the transfer table in accordance with the command transmitted from the external device (step S103). For example, the transfer table setting unit 23 performs setting by updating information of the transfer table illustrated in FIG. 7(A) as illustrated in FIG. 7(B). The transfer table setting unit 23 stores the updated transfer table in the transfer table storage unit 24.

Next, the operator performs wiring to the relay device 30 side of the transition destination OLT 20 (step S104). For example, the operator performs wiring to the relay port 221 and the relay device transfer port 222 on the relay device 30 side of the transition destination OLT 20. Since the specific processing in step S104 is described in FIG. 3(C), the description thereof is omitted.

The operator performs connection of the wiring on the relay device 30 side of the transition destination OLT 20 (step S105). For example, the operator performs connection of the wiring of the relay port 221 and the relay device transfer port 222 on the relay device 30 side of the transition destination OLT 20. Since the specific processing in step S105 is described in FIG. 3(D), the description thereof is omitted. Communication restoration of each ONU 10 is confirmed in the transition destination OLT 20 (step S106).

When the processing of step S106 is performed, data can be transmitted and received between the ONU 10 and the relay device 30 even during the transition. Specific examples will be described. First, downlink data transmission from the relay device 30 to the ONU 10 will be described. It is assumed that the data addressed to the ONU 10-1 is transferred from the relay device 30 to the transition destination OLT 20 after the processing of step S106. In this case, the transition destination OLT 20 receives, at the relay port 221, the data addressed to the ONU 10-1 transmitted from the relay device 30. On the basis of the received data and the relay port 221 receiving the data, the transfer control unit 26 refers to the transfer table stored in the transfer table storage unit 24 and determines the transfer destination of the data. In the transfer table illustrated in FIG. 7(B), in a case where the destination is the ONU 10-1 and the reception port is the relay port 221, the transfer destination is set to the relay device transfer port 222. Thus, the transfer control unit 26 transfers the received data to the relay device transfer port 222.

The relay device transfer port 222 is connected to the port 151 of the transition source OLT 15 via an optical fiber. For that reason, the data output from the relay device transfer port 222 is input to the port 151 of the transition source OLT 15. Since the ONU 10-1 is connected to the transition source OLT 15, the transition source OLT 15 transfers the received data to the ONU 10-1 that is a destination. As described above, the downlink data transmission from the relay device 30 to the ONU 10 becomes possible.

Next, uplink data transmission from the ONU 10 to the relay device 30 will be described. It is assumed that data addressed to the relay device 30 is transmitted from the ONU 10-1 to the transition source OLT 15. In this case, the transition source OLT 15 transfers the data transmitted from the ONU 10-1 to the relay device transfer port 222 of the transition destination OLT 20 via the port 151. The transition destination OLT 20 receives, at the relay device transfer port 222, the data addressed to the relay device 30 transferred from the transition source OLT 15. On the basis of the received data and the relay device transfer port 222 receiving the data, the transfer control unit 26 refers to the transfer table and determines the transfer destination of the data. In the transfer table illustrated in FIG. 7(B), in a case where the destination is the relay device 30 and the reception port is the relay device transfer port 222, the transfer destination is set to the relay port 221. Thus, the transfer control unit 26 transfers the received data to the relay port 221.

The relay port 221 is connected to the relay device 30 via an optical fiber. For that reason, the data output from the relay port 221 is input to the relay device 30. The relay device 30 transfers the received data to a relay device of a network to which a communication device as a destination belongs. As described above, the uplink data transmission from the ONU 10 to the relay device 30 becomes possible.

Next, the operator performs wiring to the ONU 10 side of the transition destination OLT 20 (step S107). For example, first, the operator performs wiring to the ONU connection port 211-1 and the transition source transfer port 213-1 of the subscriber side transfer unit 21-1 among the plurality of subscriber side transfer units 21 of the transition destination OLT 20. Since the specific processing in step S107 is described in FIG. 4(A), the description thereof is omitted.

The operator performs connection of the wiring on the ONU 10 side of the transition destination OLT 20 (step S108). For example, the operator performs connection of the wiring of the ONU connection port 211-1 and the transition source transfer port 213-1 of the subscriber side transfer unit 21-1 of the transition destination OLT 20. Since the specific processing in step S108 is described in FIG. 4(B), the description thereof is omitted. Communication restoration of the ONU 10-1 is confirmed in the transition destination OLT 20 (step S109).

Even while wiring connection work to the ONU 10-1 is being performed, the other ONUS 10 are directly connected to the transition source OLT 15 and can continue data transmission and reception with the relay device 30. In the ONU 10-1, when the processing of step S109 is performed, data can be transmitted and received between the ONU 10-1 and the relay device 30 even during the transition. Specific examples will be described. Downlink data transmission from the relay device 30 to the ONU 10-1 will be described. It is assumed that the data addressed to the ONU 10-1 is transferred from the relay device 30 to the transition destination OLT 20 after the processing of step S109. In this case, the transition destination OLT 20 receives, at the relay port 221, the data addressed to the ONU 10-1 transmitted from the relay device 30. On the basis of the received data and the relay port 221 receiving the data, the transfer control unit 26 refers to the transfer table stored in the transfer table storage unit 24 and determines the transfer destination of the data. In the transfer table illustrated in FIG. 7(B), in a case where the destination is the ONU 10-1 and the reception port is the relay port 221, the transfer destination is set to the relay device transfer port 222. Thus, the transfer control unit 26 transfers the received data to the relay device transfer port 222.

The relay device transfer port 222 is connected to the port 151 of the transition source OLT 15 via an optical fiber. For that reason, the data output from the relay device transfer port 222 is input to the port 151 of the transition source OLT 15. In the transition source OLT 15, the port 152 connected to the ONU 10-1 is connected to the transition source transfer port 213-1 of the transition destination OLT 20 by the processing of step S108. For that reason, the data addressed to the ONU 10-1 output from the transition source OLT 15 is transferred to the transition source transfer port 213-1 of the transition destination OLT 20 via the port 152.

The data input to the transition source transfer port 213-1 of the transition destination OLT 20 is input to the optical SW 214-1. Since the path is set as illustrated in FIG. 4(B) inside the optical SW 214-1, the data input to the optical SW 214-1 is output to the ONU connection port 211-1. The ONU 10-1 is connected to the ONU connection port 211-1 by the processing of step S108. For that reason, the data output from the ONU connection port 211-1 is transferred to the ONU 10-1.

Uplink data transmission from the ONU 10-1 to the relay device 30 is similar to the processing after the connection of the wiring on the relay device 30 side is performed except that the data is transferred to the transition source OLT 15 via the optical SW 214-1. Thus, only a point will be described that the data is transferred to the transition source OLT 15 via the optical SW 214-1. It is assumed that data addressed to the relay device 30 is transmitted from the ONU 10-1 to the transition destination OLT 20. In this case, the transition destination OLT 20 receives the data transmitted from the ONU 10-1 at the ONU connection port 211-1. The data received at the ONU connection port 211-1 is output from the transition source transfer port 213-1 via the optical SW 214-1. In the setting of the transfer table, the setting is made so that the data received at the ONU connection port 211-1 is “not transferred”, but since the setting of the transfer table is not related to transfer in the optical SW 214-1, the data is transferred in the optical SW 214-1. The data output from the transition source transfer port 213-1 is input to the transition source OLT 15. The subsequent processing is similar to the processing after the connection of the wiring on the relay device 30 side is performed.

The operator executes the processing from step S107 to step S109 as many as the number of ONUs 10 connected to the transition source OLT 15. As a result, all the ONUs 10 connected to the transition source OLT 15 are connected to the transition destination OLT 20. Thereafter, the operator operates the external device to give an instruction for switching of the optical SW 214 of the transition destination OLT 20 (step S110). For example, the operator operates the external device to give an instruction for switching of the optical SW 214-1 of the transition destination OLT 20. The external device transmits a switching instruction for the optical SW 214-1 to the transition destination OLT 20.

The optical SW control unit 25 performs switching of the path of the optical SW 214 of the subscriber side transfer unit 21 on the basis of the switching instruction transmitted from the external device (step S111). For example, the optical SW control unit 25 performs switching of the path of the optical SW 214-1 of the subscriber side transfer unit 21-1. The optical SW control unit 25 performs switching of the path of the optical SW 214-1 so that conduction between the ONU connection port 211-1 and the port 212-1 is made. As a result, connection between the ONU 10-1 and the relay device 30 is disconnected, whereby communication interruption occurs in the ONU 10-1. Connection with the ONU 10-1 is confirmed in the transition destination OLT 20 (step S112).

If no particular problem is found in the connection with the ONU 10-1, the operator operates the external device to perform setting of the transfer table of the transition destination OLT 20 (step S113). For example, the operator performs setting of the transfer table of the transition destination OLT 20 on the basis of the transfer table illustrated in FIG. 7(B).

The operator first operates the external device to transmit, to the transition destination OLT 20, a command for causing Content 4 described below to be set in the transfer table.

(Content 4) A content for causing a destination “ONU 10-1”, a reception port “relay port 221”, and a transfer destination “ONU connection port 211-1” to be set.

Content 4 is a content for causing settings to be set so that in a case where the data whose destination is the destination ONU 10-1 is received at the relay port 221 of the transition destination OLT 20, the received data is transferred to the ONU connection port 211-1.

The transfer table setting unit 23 performs setting of the transfer table in accordance with the command transmitted from the external device (step S114). For example, the transfer table setting unit 23 performs setting by updating information of the transfer table illustrated in FIG. 7(B) as illustrated in FIG. 7(C). The transfer table setting unit 23 stores the updated transfer table in the transfer table storage unit 24.

The operator then operates the external device to transmit, to the transition destination OLT 20, a command for causing Content 5 described below to be set in the transfer table.

(Content 5) A content for causing a destination “relay device 30”, a reception port “ONU connection port 211-1”, and a transfer destination “relay port 221” to be set.

Content 5 is a content for causing settings to be set so that in a case where the data whose destination is the relay device 30 is received at the ONU connection port 211-1 of the transition destination OLT 20, the received data is transferred to the relay port 221. Note that, in Content 5, the branch number of the ONU connection port 211 changes depending on the ONU 10 that is a switching target.

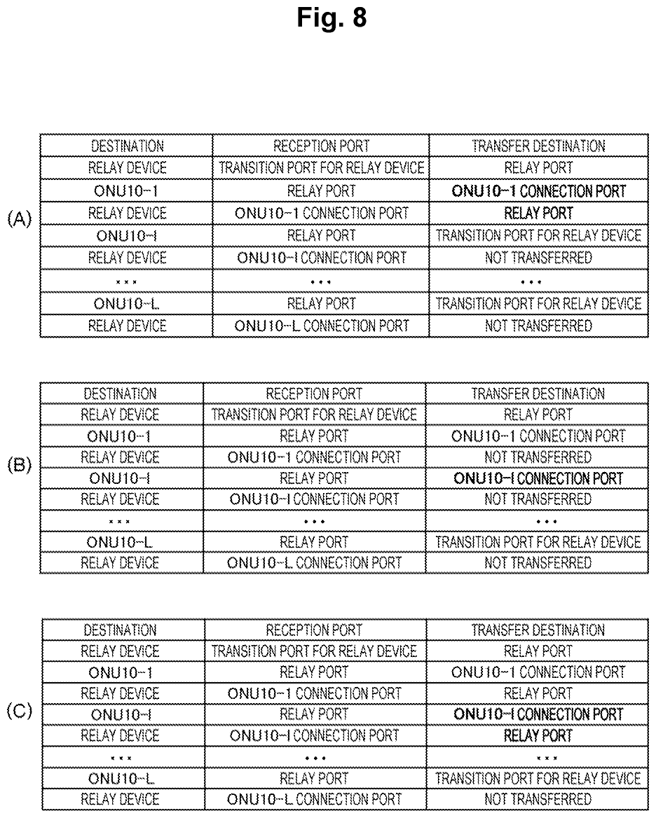

The transfer table setting unit 23 performs setting of the transfer table in accordance with the command transmitted from the external device. For example, the transfer table setting unit 23 performs setting by updating information of the transfer table illustrated in FIG. 7(C) as illustrated in FIG. 8(A). The transfer table setting unit 23 stores the updated transfer table in the transfer table storage unit 24. Communication restoration of the ONU 10-1 is confirmed in the transition destination OLT 20 (step S115).

With the processing from step S111 to step S115, the ONU 10-1 can transmit and receive data to and from the relay device 30. Specific examples will be described. The downlink data transmission from the relay device 30 to the ONU 10-1 will be described. It is assumed that the data addressed to the ONU 10-1 is transferred from the relay device 30 to the transition destination OLT 20 after the processing of step S114. In this case, the transition destination OLT 20 receives, at the relay port 221, the data addressed to the ONU 10-1 transmitted from the relay device 30. On the basis of the received data and the relay port 221 receiving the data, the transfer control unit 26 refers to the transfer table stored in the transfer table storage unit 24 and determines the transfer destination of the data. In the transfer table illustrated in FIG. 8(A), in a case where the destination is the ONU 10-1 and the reception port is the relay port 221, the transfer destination is set to the ONU connection port 211-1. Thus, the transfer control unit 26 transfers the received data to the ONU connection port 211-1 via the optical SW 214-1 in the subscriber side transfer unit 21-1. The ONU connection port 211-1 is connected to the ONU 10-1 via an optical fiber. For that reason, the data output from the ONU connection port 211-1 is input to the ONU 10-1. As described above, the downlink data transmission from the relay device 30 to the ONU 10-1 becomes possible.

Next, the uplink data transmission from the ONU 10-1 to the relay device 30 will be described. It is assumed that data addressed to the relay device 30 is transmitted from the ONU 10-1 to the transition destination OLT 20. In this case, the transition destination OLT 20 receives the data transmitted from the ONU 10-1 at the ONU connection port 211-1. The data received at the ONU connection port 211-1 is input to the transfer control unit 26 via the optical SW 214-1. On the basis of the received data and the ONU connection port 211-1 receiving the data, the transfer control unit 26 refers to the transfer table and determines the transfer destination of the data. In the transfer table illustrated in FIG. 8(A), in a case where the destination is the relay device 30 and the reception port is the ONU connection port 211-1, the transfer destination is set to the relay port 221. Thus, the transfer control unit 26 transfers the received data to the relay port 221. The relay port 221 is connected to the relay device 30 via an optical fiber. For that reason, the data output from the relay port 221 is input to the relay device 30. As described above, the uplink data transmission from the ONU 10-1 to the relay device 30 becomes possible.

As described above, communication between the ONU 10-1 and the relay device 30 can be performed without passing through the transition source OLT 15. On the other hand, the ONUS 10 other than the ONU 10-1 communicate with the relay device 30 via the transition source OLT 15 because the processing from step S111 to step S115 is not executed.

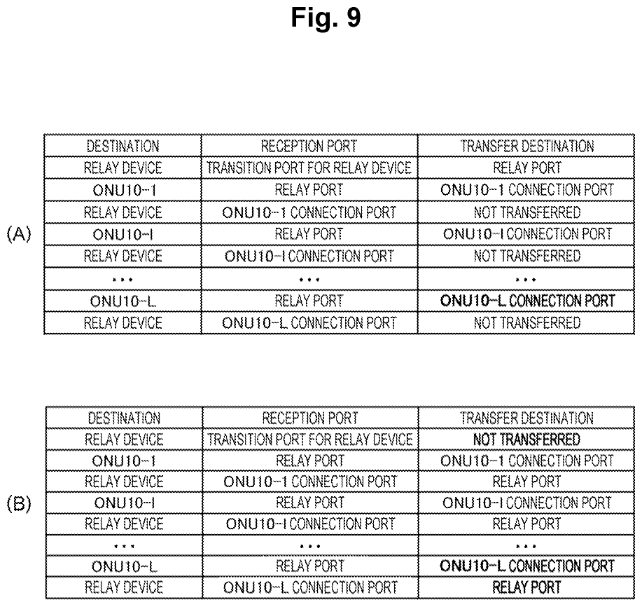

The operator executes the processing from step S111 to step S115 as many as the number of ONUS 10 connected to the transition destination OLT 20. For example, after completing the processing from step S111 to step S115 for one ONU 10 connected to the transition destination OLT 20, the operator executes the processing from step S111 to step S115 for the next ONU 10. As a result, the transfer table setting unit 23 updates the information of the transfer table for each ONU 10. For example, the transfer table setting unit 23 updates the information of the transfer table in the order of FIGS. 8(B), 8(C), 9(A), and 9(B).

At the time of setting of the transfer table related to the ONU 10-L for which setting is to be performed last, the operator operates the external device to transmit, to the transition destination OLT 20, a command for causing Content 6 described below to be set in the transfer table in addition to Content 5.

(Content 6) A content for causing a destination “relay device 30”, a reception port “relay device transfer port 222”, and a transfer destination “not transferred” to be set.

Content 6 is a content for causing settings to be set so that in a case where the data whose destination is the relay device 30 is received at the relay device transfer port 222 of the transition destination OLT 20, the received data is not transferred. This is because, in a case where all the ONUs 10 are connected to the transition destination OLT 20 and the setting of communication with the relay device 30 is completed, there is no need to transfer the data to the transition source OLT 15.

With the above processing, all the ONUs 10 connected to the transition destination OLT 20 can communicate with the relay device 30 without passing through the transition source OLT 15. Thereafter, the operator removes the transition source OLT 15 and unnecessary wiring (step S116).

According to the optical access system 1 configured as described above, it is possible to suppress an influence of communication interruption in transition of a device. Specifically, the transition destination OLT 20 includes the relay device transfer port 222 that transfers the data transferred from the relay device 30 to return the data to the transition source OLT 15, and the transition source transfer port 213 that transfers the data transmitted from each ONU 10 to return the data to the transition source OLT 15. At the time of transition of the OLT, after the connection with the relay device 30 is switched to the transition destination OLT 20, the transition destination OLT 20 transfers the data transferred from the relay device 30 to the transition source OLT 15 via the relay device transfer port 222. Further, after the connection with the ONU 10 is switched to the transition destination OLT 20, the transition destination OLT 20 transfers the data transmitted from each ONU 10 to the transition source OLT 15 via the transition source transfer port 213, whereby it is possible to continue user's communication even at the time of switching of the other ONUS 10. Then, after the switching of all the ONUS 10 is ended, the data transfer to the transition source OLT 15 is stopped, and processing is performed in the transition destination OLT 20, whereby the user's communication interruption time can be shortened. For that reason, it is possible to suppress the influence of communication interruption.

In the transition destination OLT 20, since the switching is performed individually for the relay device 30 and each ONU 10, even in a case where a problem occurs in the setting of the transition destination OLT 20, or the like, the switch-back can be easily performed.

The communication interruption seen from the user terminal 40 intermittently occurs at the time of connection switching of the relay device 30, connection switching of the ONU 10, and path switching of the optical SW 214, but it is possible to reduce the number of steps between one communication interruption and completion confirmation as in the conventional method, and it is possible to suppress the communication interruption caused by waiting for completion of a step related to another user.

In the conventional method, whether or not the transfer setting is successfully copied and converted, and whether or not the port of the connection switching destination is correctly connected, are confirmed after the connection switching or the setting change is performed, but whether or not they are correctly performed so that the user's communication finally is restored cannot be confirmed until both the relay device side connection line and the ONU side connection line are switched. If the communication is not restored, there has been a problem that a switch-back step is complicated, it takes time for cause investigation, and the communication interruption increases considerably.

On the other hand, in the optical access system 1, whether or not the transfer setting is successfully copied and converted, and whether or not the port of the connection switching destination is correctly connected can be confirmed in a form of user's communication restoration for each piece of work. As a result, a switch-back determination can be made in each step, and it is possible to suppress an increase in the communication interruption time due to the switch-back work.

Since connection work between the transition destination OLT 20 and the relay device 30 and connection work between the transition destination OLT 20 and the ONU are physical configurations, local work is required; however, update of the transfer table and switching of the optical SW 214 can be performed collectively and remotely, and its step can be divided. For that reason, appropriate technicians and time can be allocated to each step.

In the optical access system 1 in the present embodiment, two connection procedures after connection disconnection are required at each of connection changes in FIGS. 3(C) and 4(A). In a case where transition is performed to the transition destination OLT 20 and then transition to another OLT is further performed, connection between the transition source OLT 15 and the transition destination OLT 20 in FIG. 3(D) can be performed without communication interruption, and a connection procedure in the next transition can be simplified.

The transition destination OLT 20 may perform switching of the ONUs 10 in any order.

Some functions (for example, processing of updating the transfer table by the transfer table setting unit 23) of the transition destination OLT 20 in the embodiment described above may be implemented by a computer. In that case, a program for implementing these functions may be recorded in a computer-readable recording medium, and the program recorded in the recording medium may be read and executed by a computer system to implement the functions. Note that the “computer system” mentioned herein includes an OS and hardware such as a peripheral device. Also, the “computer-readable recording medium” refers to a portable medium such as a flexible disk, a magneto-optical disk, a ROM, or a CD-ROM, or a storage device such as a hard disk included in the computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside the computer system serving as a server or a client in that case. Also, the above program may be for implementing some of the functions described above, may be formed with a combination of the functions described above and a program already recorded in the computer system, or may be formed with a programmable logic device such as an FPGA.

Although the embodiment of the present invention has been described in detail with reference to the drawings so far, the specific configuration is not limited to this embodiment, and includes a design and the like without departing from the scope of the present invention.

### INDUSTRIAL APPLICABILITY

The present invention can be applied to a technology associated with transition of an optical communication device.

### REFERENCE SIGNS LIST

10-1 to 10-L ONU
15 transition source OLT
20 transition destination OLT
30 relay device
21-1 to 21-N subscriber side transfer unit
22 relay device side transfer unit
23 transfer table setting unit
24 transfer table storage unit
25 optical SW control unit
26 transfer control unit
211 ONU connection port
212 port
213 transition source transfer port
214 optical SW
221 relay port
222 relay device transfer port

1. A transition destination subscriber line terminal station device in an optical access system including: a transition source subscriber line terminal station device before device replacement, the transition source subscriber line terminal station device communicating with a higher-level device and one or more subscriber line terminal devices; and the transition destination subscriber line terminal station device that is a device replacement destination,
the transition destination subscriber line terminal station device comprising:
a higher-level device side transition unit including a higher-level port for connecting to the higher-level device and a first transition port that transfers data transferred from the higher-level device to the transition source subscriber line terminal station device;
a subscriber side transfer unit including subscriber side connection ports for connecting to one or more subscriber line terminal devices, and a second transition port that transfers data transmitted from the subscriber line terminal devices to the transition source subscriber line terminal station device;
a transfer table setting unit that changes a setting of a transfer table in which a port at which data is received, a destination of the data, and a port of a transfer destination of the data are associated with each other; and
a transfer control unit that performs data transfer to the transition source subscriber line terminal station device via at least the first transition port in accordance with the transfer table.

2. The transition destination subscriber line terminal station device according to claim 1, wherein the transfer table setting unit changes, at a start of the device replacement, the setting of the transfer table such that data addressed to the subscriber line terminal devices received at the higher-level port is transferred to the first transition port, and data addressed to the higher-level device received at the first transition port is transferred to the higher-level port.

3. The transition destination subscriber line terminal station device according to claim 2, wherein the transfer table setting unit, after the subscriber line terminal devices are respectively connected to the subscriber side connection ports, changes the setting of the transfer table such that data received at the subscriber side connection ports is transferred to the higher-level port.

4. The transition destination subscriber line terminal station device according to claim 1, wherein
a plurality of the subscriber side transfer units is included,
each of the subscriber side transfer units is provided with an optical switch,
an optical switch control unit that controls switching of a connection path of the optical switch is further included,
the optical switch is enabled to perform switching of the path to make conduction between the subscriber side connection ports and the second transition port or a port that outputs data inside the device, and the path is set to make conduction between the subscriber side connection ports and the second transition port at the start of the device replacement, and
the optical switch control unit, after the subscriber line terminal devices are respectively connected to the subscriber side connection ports, performs switching of the path of the optical switch to make conduction between the subscriber side connection port and the port inside the device.

5. The transition destination subscriber line terminal station device according to claim 4, wherein the optical switch control unit performs switching of the path of the optical switch that makes conduction between one of the subscriber side connection ports and the port inside the device, in one of the subscriber side transfer units, and performs switching of the path of the optical switch that makes conduction between one of the subscriber side connection ports and the port inside the device, in the other subscriber side transfer units each time a setting change of the transfer table for one of the subscriber side transfer units is completed.

6. The transition destination subscriber line terminal station device according to claim 5, wherein the transfer table setting unit, after the optical switch control unit performs switching of the path of the optical switch that makes conduction between one of the subscriber side connection ports and the port inside the device, in one of the subscriber side transfer units, changes the setting of the transfer table such that data output from the port inside the device where switching of the path of the optical switch is performed is transferred to the higher-level port.

7. A transfer method performed by a transition destination subscriber line terminal station device in an optical access system including: a transition source subscriber line terminal station device before device replacement, the transition source subscriber line terminal station device communicating with a higher-level device and one or more subscriber line terminal devices; and the transition destination subscriber line terminal station device that is a device replacement destination, the transfer method comprising:
transferring, to the transition source subscriber line terminal station device, data transmitted from the higher-level device, via a first transition port connected to the transition source subscriber line terminal station device after a connection with the higher-level device is switched from the transition source subscriber line terminal station device to the transition destination subscriber line terminal station device; and
transferring, to the transition source subscriber line terminal station device, data transmitted from the one or more subscriber line terminal devices, via a second transition port connected to the transition source subscriber line terminal station device after connections with the one or more subscriber line terminal devices are switched from the transition source subscriber line terminal station device to the transition destination subscriber line terminal station device.

8. An optical access system comprising: a transition source subscriber line terminal station device before device replacement, the transition source subscriber line terminal station device communicating with a higher-level device and one or more subscriber line terminal devices; and a transition destination subscriber line terminal station device that is a device replacement destination,
wherein
the transition destination subscriber line terminal station device includes:
a higher-level device side transition unit including a higher-level port for connecting to the higher-level device and a first transition port that transfers data transferred from the higher-level device to the transition source subscriber line terminal station device;
a subscriber side transfer unit including subscriber side connection ports for connecting to one or more subscriber line terminal devices, and a second transition port that transfers data transmitted from the subscriber line terminal devices to the transition source subscriber line terminal station device; and
a transfer control unit that performs data transfer to the transition source subscriber line terminal station device via at least the first transition port at a time of device replacement, and
in the transition source subscriber line terminal station device,
with a start of device replacement, a port that has been connected to the higher-level device is connected to the first transition port, and ports that have been connected to the one or more subscriber line terminal devices are connected to the second transition port, and
data transferred from the first transition port is transferred to a destination via the second transition port, and data transferred from the first transition port is transferred to a destination via the second transition port.
